(19) United States
(12) Patent Application Publication
(10) Pub. No.: US 2010/0181518 A1
(43) Pub. Date: Jul. 22, 2010

(54) VALVE SPRING FOR A PLATE VALVE

(75) Inventor: Marco KOWALSKI, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/687,960

(22) Filed: Jan. 15, 2010

(30) Foreign Application Priority Data
Jan. 16, 2009 (DE) 10 2009 004 863.4

(51) Int. Cl. F16K 1/00

(52) U.S. Cl. 251/324

(57) ABSTRACT

A plate valve designed as a hydraulic one-way valve, which has a valve plate, a one-piece valve spring and a holding element. The plate valve is integrated into a piston and is assigned to a feed opening. The rotationally symmetrical plate valve is inserted into a receptacle in the piston. The valve spring, which is positioned between the valve plate and the holding element, is designed as a perforated disk, on the inside of which at least two separate spring tongues of wound design arranged offset with respect to one another are provided, the spring tongues being supported in non-positive engagement against a valve plate.

### FIELD OF THE INVENTION

The invention relates to a plate valve designed as a hydraulic one-way valve, which comprises a valve plate, a one-piece valve spring and a holding element. The plate valve is integrated into a housing and is assigned to a control opening.

### BACKGROUND OF THE INVENTION

EP 0 919 744 A1 discloses a disk-shaped valve member which is intended as a check valve for a tensioning device. At the upper end of the valve member there is a tappet, which is arranged in a sleeve of the filling element in the interior of the tensioning piston. The tappet is guided in the sleeve with a metal ring between them, the said ring exerting a radial force, with the result that displacing of the tappet is associated with friction. Owing to this frictional connection between the plate-shaped valve member and the tensioning piston, the opening and closure of the valve member is associated directly with the movement of the tensioning piston.

U.S. Pat. No. 4,940,447 has disclosed a tensioning device with a closed oil circuit. In this device, oil is exchanged between two chambers via a check valve for damping purposes. In at least one embodiment, a plate-shaped valve member is used, the said member being accommodated loosely in a valve cage.

It is a common feature of these known plate valves that they require a relatively large installation space, and this has a direct effect on the space required for the installation of the hydraulic valve of the tensioning device.

### OBJECT OF THE INVENTION

The object on which the present invention is based is to create a plate valve that is optimized in terms of installation space and can be produced at a reasonable cost.

### SUMMARY OF THE INVENTION

To achieve the present object, the invention provides a hydraulic valve designed as a plate valve, in which the components of the plate valve, which are of rotationally symmetrical design, are inserted into a receptacle in a housing. The valve spring, which is positioned between the valve plate and the holding element, is designed as a perforated disk, with, on the inside, at least two separate spring tongues of wound design arranged offset with respect to one another. When installed, these spring tongues, which are spaced apart with an arcuate boundary, are supported at one end against the valve plate, whereby advantageously, corresponding to the number of spring tongues, an almost punctiform contact area arises. By virtue of this support of the valve spring against the valve plate, a defined and largely stationary force transmission from the valve spring to the valve plate arises. As a result, the valve element has a low restoring force combined with a short response time, i.e. the valve element opens quickly when a differential pressure arises between the reservoir space and the pressure or high-pressure space. The spring tongues are positioned in such a way that there is no wear on the valve spring due to contact between the spring tongues. Furthermore, a maximum overall height is advantageously obtained in the fully compressed position of the valve spring according to the invention, the said overall height corresponding to the thickness of the valve spring component, thereby making it possible to make more effective use of the spring travel and at the same time to achieve higher spring forces. For geometrical reasons, such as a relatively large sheet thickness and the relatively large width of the spring tongues, significantly higher spring forces occur in comparison with previously conventional helical compression springs.

By virtue of the design of the plate, the valve spring concept according to the invention is moveable only in the axial direction. Radial movement or twisting is impossible because of jamming of the holding element. Moreover, the valve spring designed in accordance with the invention does not kink or buckle.

Significant advantages as regards dynamics, responsiveness, i.e. a rapid buildup of damping force, and service life can be achieved with the valve spring according to the invention, and this proves advantageous especially when using the valve spring in plate valves for hydraulic tensioning systems. With the valve spring according to the invention, it is possible to achieve valve dynamics of >100 Hz, for example.

Further advantageous embodiments of the invention form the subject matter of dependent claims 2 to 6.

The valve spring preferably has three spring tongues arranged in a symmetrically distributed manner, thereby ensuring optimum support for the valve spring on the valve plate. A suitable and preferred material for the production of the valve spring is a thin steel or spring plate. As an alternative, the valve spring can be produced from plastic. Irrespective of the material, the spring tongues are designed or preshaped in such a way that they ensure a permanent preload in the installed condition. A component thickness of 5 mm is preferably provided for the plate valve according to the invention.

The installation position provided for the valve spring is one in which the valve plate is acted upon with nonpositive engagement in the closing direction of the plate valve.

This valve spring according to the invention is intended preferably for a plate valve that is inserted into a hydraulic tensioning element of a traction mechanism drive.

The valve spring according to the invention is preferably used for plate valves of hydraulic tensioning elements of a traction mechanism drive. In terms of its construction, this tensioning element comprises a housing, in which a spring-loaded piston, delimiting a pressure space filled with hydraulic fluid, is guided. Fluid enters the pressure space from a reservoir space and a control opening on the housing side, for example, via the plate valve. The plate valve according to the invention, which is optimized in terms of installation space and is intended, in particular, for use in tensioning systems of chain drives, can be inserted into a piston, for example, in order to allow a flow of fluid from a reservoir space to a high-pressure space and prevent a flow of fluid in the reverse direction.

### BRIEF DESCRIPTION OF THE DRAWINGS

The invention is explained in greater detail by means of an exemplary embodiment with reference to two drawings, in which:

FIG. 1 shows a side view of a hydraulic tensioning element with a plate valve, to which a valve spring according to the invention is assigned;

FIG. 2 shows a detail of the piston in FIG. 1 on an enlarged scale;

FIG. 3 shows the valve spring according to the invention in a top view; and

FIG. 4 shows all the individual components of the plate valve.

### DETAILED DESCRIPTION OF THE DRAWINGS

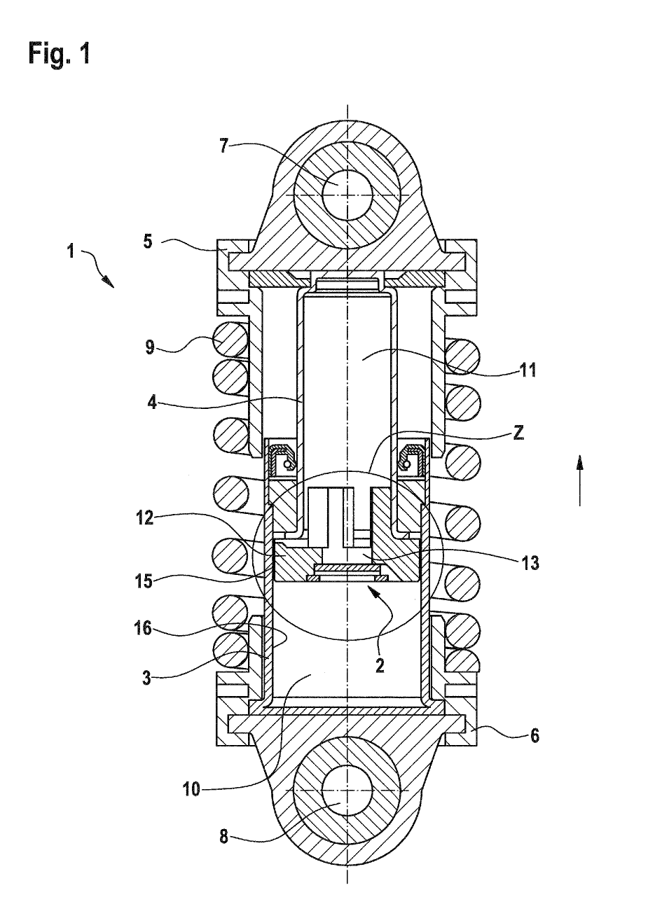

FIG. 1 shows a hydraulic tensioning element 1 for a traction mechanism drive with an integrated plate valve 2. The tensioning element 1 comprises a cylinder 3, in which a piston 4 is guided in a longitudinally displaceable manner. The cylinder 3 and the piston 4 are assigned to separate housings 5, 6, which each have a corresponding fastening lug 7, 8. A compression spring 9 around the outside of the cylinder 3 and the piston 4 produces a spreading force between these components. The piston 4 delimits a pressure space 10 enclosed in the cylinder 3 and filled with a hydraulic fluid. To allow the pressure space 10 to be supplied with the hydraulic fluid from a reservoir space 11 integrated into the piston 4, a feed bore 13 is introduced centrally in a base 12 of the piston 4. A plate valve 15 connected to the feed bore 13 is inserted as a one-way valve in a receptacle 14 in the piston base.

During an actuating movement of the piston 4 in a direction opposite to that of the arrow, the hydraulic fluid is displaced from the pressure space 10 via a leakage gap 15 which arises between the piston 4 and an interior wall 16 of the cylinder 3 and passes via an aperture 17 into the reservoir space 11 of the piston 4. The increased pressure which arises in the pressure space 10 during this process presses a valve plate 18 of the plate valve 2 against a valve seat 20 in the base 12. In the case of a piston movement in the direction of the arrow, a suction or low pressure arises in the pressure space 10 and triggers opening of the plate valve 2 as soon as the low pressure exceeds a supporting force of a valve spring 19 acting upon the valve plate 18 in the closing direction, thereby allowing hydraulic fluid to pass out of the reservoir space via the feed bore 6 into the pressure space 4.

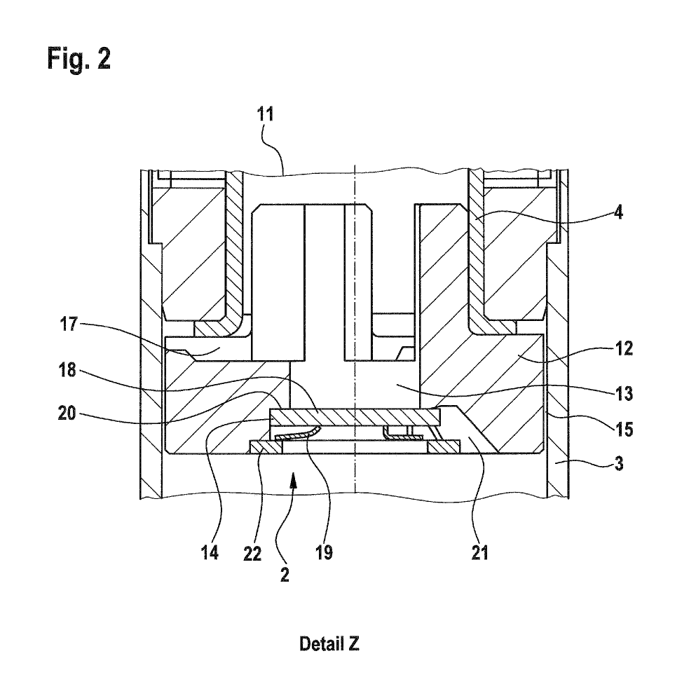

FIG. 2 shows the installation position of the plate valve 2 on a larger scale and clarifies further details. The valve plate 18 is centered in the receptacle 14 in the piston base and, in this position, it is connected to a feed duct 21 for the purpose of a targeted incident flow. A holding element 22, which is fixed to the base, and the valve spring 19 ensure that the installation position of the valve plate 18 is stable.

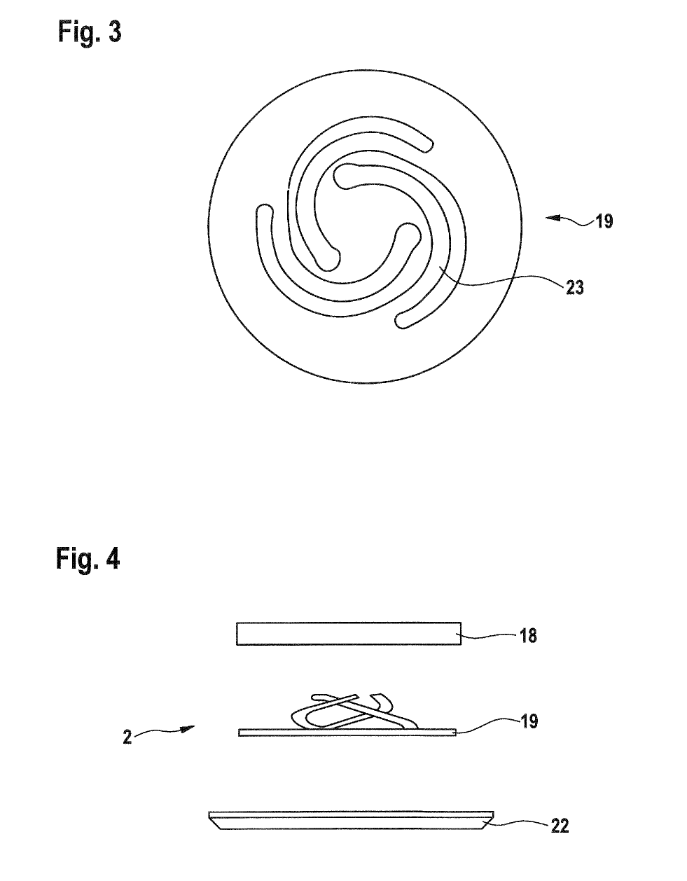

In FIG. 3, the valve spring 19 is depicted as an individual component, which is designed as a perforated disk and, on the inside, has three separately arranged spring tongues 23 of wound design.

FIG. 4 shows an exploded view of all the individual components of the plate valve 2, the holding element 22, the valve spring 19 and the valve plate 18.

### LIST OF REFERENCES

1 Tensioning element
2 Plate valve
3 Cylinder
4 Piston
5 Housing
6 Housing
7 Fastening lug
8 Fastening lug
9 Compression spring
10 Pressure space
11 Reservoir space
12 Base
13 Feed bore
14 Receptacle
15 Leakage gap
16 Interior wall
17 Aperture
18 Valve plate
19 Valve spring
20 Valve seat
21 Feed duct
22 Holding element
23 Spring tongue

1. A plate valve designed as a hydraulic one-way valve, comprising:
a valve plate;
a one-piece valve spring; and
a holding element,
the plate valve being integrated into a housing and assigned to a feed bore,
wherein the components of the plate valve, which are of rotationally symmetrical design, are centered in a receptacle in a piston, and a valve spring, which is positioned between a valve plate and the holding element, is designed as a perforated disk, on an inside of which at least two separately arranged spring tongues of wound design are arranged.

2. The plate valve to of claim 1, wherein the valve spring has three spring tongues arranged in a symmetrically distributed manner.

3. The plate valve of claim 1, wherein the valve spring is produced from a thin spring plate.

4. The plate valve of claim 1, wherein the valve spring is produced from plastic.

5. The plate valve of claim 1, wherein the valve spring is inserted under a preload in a closing direction of the plate valve.

6. The plate valve, which is intended for a hydraulic tensioning element of a traction mechanism drive, according to claim 1, wherein the plate valve is inserted into a piston, and is open in the case of a direction of fluid flow from a reservoir space to a pressure space and is closed in the case of a reverse direction of fluid flow.
